(19) United States
(12) Patent Application Publication
(10) Pub. No.: US 2024/0162441 A1
(43) Pub. Date: May 16, 2024

(54) Battery with an Organic Cathode and a Solid Electrolyte

(71) Applicant: The Regents of the University of California, Oakland, CA (US)

(72) Inventors: Robert JONSON, Berkeley, CA (US); Michael TUCKER, Piedmont, CA (US)

(21) Appl. No.: 18/504,478

(22) Filed: Nov. 8, 2023

Related U.S. Application Data
(60) Provisional application No. 63/425,334, filed on Nov. 15, 2022.

(51) Int. Cl. H01M 4/60; H01M 4/38; H01M 4/62; H01M 12/02; H01M 4/02

(52) U.S. Cl. CPC H01M 4/60; H01M 4/382; H01M 4/625; H01M 12/02; H01M 2004/027; H01M 2004/028; H01M 4/622; H01M 2300/0077

(57) ABSTRACT

This disclosure provides systems, methods, and apparatus related to batteries with an organic cathode and a solid electrolyte. In one aspect, a device includes an anode, a cathode, and a separator disposed between the anode and the cathode. The anode comprises lithium. The cathode comprises a catholyte and an organic active material disposed therein. The separator comprises a solid-state electrolyte.

### RELATED APPLICATIONS

This application claims priority to U.S. Provisional Patent Application No. 63/425,334, filed Nov. 15, 2022, which is herein incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### TECHNICAL FIELD

This disclosure relates generally to batteries and more particularly to batteries with an organic cathode and a solid electrolyte.

### BACKGROUND

Quinones are among the more interesting organic materials being explored for use as cathode materials in Li batteries. Quinones offer several advantages compared to conventional inorganic cathode materials. They have high specific capacity (up to 496 mAh/g for 1,4-benzoquinone); contain no metal atoms and many can be biologically derived or sustainably synthesized; and, they can be used with many battery chemistries, including Li, Na, Mg, and Zn.

Unfortunately, quinones generally have low ionic and electronic conductivity, necessitating high cathode-side carbon and catholyte content, and low-molecular-weight quinones can dissolve into liquid electrolytes and cause cell failure. Common strategies to avoid dissolution include binding quinones to polymers or synthesizing larger, less soluble quinone molecules. The resulting high molecular weight leads to lower volumetric and specific capacity compared to the underlying small-molecule quinone materials. One research group developed an alternative two-compartment cell that used a lithium-conducting glass-ceramic membrane to separate electrode chambers containing liquid electrolyte.

### BRIEF DESCRIPTION OF THE DRAWINGS

FIGS. 1A-1D show a comparison of liquid-soaked Celgard and solid LLZO separators. Performance of LilLawsone battery cells in both hybrid LLZO solid-separator/liquid-catholyte and full liquid-electrolyte configurations are shown FIG. 1A shows the cycling performance of a liquid cell and an LLZO cell at several rates. FIG. 1B shows that the self-discharge OCV holds over 72 hours. FIG. 1C shows an illustration of the lawsone lithiation reactions. FIG. 1D shows charge/discharge curves at several rates of an LLZO cell with 1:9 mol. LiTFSI:PYR13FSI electrolyte. Cycles 1, 2, 10 and 20 have a rate of 0.24 C while cycles 30, 40, and 50 were at 0.30 C, 0.46 C, and 0.12 C respectively.

FIGS. 2A-2C shows the impact of catholyte. FIG. 2A shows the performance of LLZO cells with several different liquid catholytes. Charge/discharge differential capacity curves for a cell with EC:DMC and 1M LiFSI (FIG. 2B) and LiFSI:PYR13FSI (FIG. 2C) are shown.

FIGS. 3A-3D show the catholyte impedance. These figures show Nyquist plots of LLZO cells before and after cycling with LiPF6 EC:DMC:DEC (FIGS. 3A and 3B; FIG. 3B is an enlarged portion of the box shown in FIG. 3A) and LiTFSI PYR13FSI (FIGS. 3C and 3D; FIG. 3D is an enlarged portion of the box shown in FIG. 3C).

FIG. 4 shows the impact of lower cutoff voltage-cycling performance of LS LLZO cells with LiTFSI:PYR13FSI catholyte using an upper cutoff voltage of 2.8 V and lower cutoff voltages varying between 1.6 and 2.1 V.

FIGS. 5A and 5B show an analysis of lower cutoff voltage. Differential capacity of LS LLZO cells with LiTFSI:PYR13FSI catholyte with lower cutoff voltages between 1.6 and 2.1 V in the 20^{th} cycle (FIG. 5A) and 60^{th} cycle (FIG. 5B) are shown.

FIGS. 6A and 6B show the cycling performance (FIG. 6A) and charge/discharge curves (FIG. 6B) of NQ cells with 1M LiFSI in EC:DEC catholyte.

FIG. 7 shows an example of a cross-sectional schematic illustration of a battery.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

LLZO has attracted a lot of attention as an electrolyte material for next-generation solid-state lithium batteries because of its combination of high ionic conductivity (>1 mS/cm at room temperature), stability against Li metal anodes, wide electrochemical window (>6 V), applications in flexible composite electrolytes, and nonflammability. Practical battery systems using LLZO electrolytes, however, have been difficult to achieve because of a number of challenges, including the creation of a stable, low-impedance solid-state interface between the LLZO and cathode materials. For example, common commercial cathodes such as LiFePO₄, LiMn₂O₄, LiCoO₂, and NMCs react and form high-impedance interfaces with LLZO at temperatures <700° C., preventing co-sintering of the materials as a way to form strong bonding. Lower-temperature in situ synthesis of cathode materials from metal salts infiltrated into LLZO scaffolds has been found to create good bonding; however, it is difficult to achieve practical cathode loadings with this technique. One method of achieving high loading is to adopt a hybrid cell configuration that uses some amount of polymer or liquid catholyte as a low-impedance interface material.

Of particular interest are hybrid cells with LLZO separator and liquid catholyte, using sulfur as a cathode. This cathode material suffers from a dissolution-based degradation mechanism known as the polysulfide shuttle. In these hybrid cells, LLZO blocks transport of dissolved polysulfides to the anode side. Reported sulfur utilization in the first cycle was 74 to 38%, and capacity retention was 88.4% over 9 cycles, 77.5% over 32 cycles, or 62.3% over 200 cycles. One research group claims incomplete utilization was due to the dissolution of sulfur to polysulfides and the formation of a reactive interfacial layer between the LLZO and liquid catholyte.

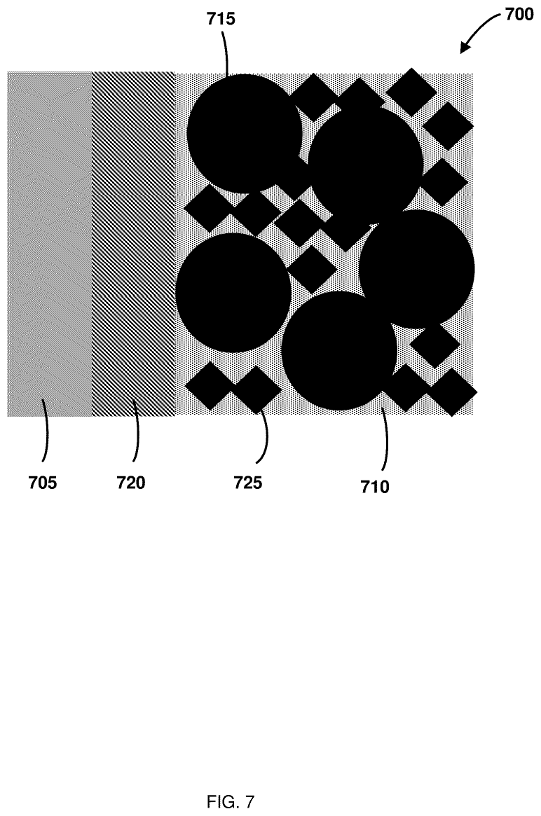

As described herein, a solid electrolyte (e.g., a lithium garnet ceramic solid electrolyte Li6.25AL0.25La3Zr2O12 (LLZO)) is used as a substantially impermeable membrane to block unwanted transport of dissolved organic molecules (e.g., small quinone molecules) in a hybrid cell with solid electrolyte and catholyte (e.g., liquid or solid). FIG. 7 shows an example of a cross-sectional schematic illustration of a battery. As shown in FIG. 7, the battery 700 includes an anode 705, a cathode comprising a catholyte 710 with an organic active material 715 disposed therein, and a separator 720 disposed between the anode 705 and the cathode. The separator comprises a solid-state electrolyte.

In some embodiments, the organic active material is an organic active material from a group a quinone, an organosulfur material, a sulfonated polyaniline, an imine material, an azo material, an organic acid anhydride, and an imide. In some embodiments, the cathode comprises about 30 vol % to 70 vol %, about 50 vol %, about 70 vol %, at least about 50 vol %, or at least about 70 vol %, of the organic active material.

In some embodiments, the organic active material is a quinone. In some embodiments, the quinone is a quinone from a group 2-hydroxy-1,4-naphthoquinone, 1,4-naphthoquinone, and 2-methyl-1,4-naphthoquinone. In some embodiments, the quinone is or comprises 2-hydroxy-1,4-naphthoquinone (lawsone). In some embodiments, the cathode comprises at least 50 vol % quinone.

In some embodiments, the organic active material is an azo material. In some embodiments, the azo material is azobenzene. In some embodiments, the cathode comprises at least 50 vol % azo material.

In some embodiments, the organic active material is an organic acid anhydride. In some embodiments, the organic acid anhydride is an organic acid anhydride from a group perylene tetracarboxylic dianhydride (PTCDA) and pyromellitic dianhydride (PMDA). In some embodiments, the cathode comprises at least 50 vol % organic acid anhydride.

In some embodiments, the organic active material is an imide. In some embodiments, the imide is a pyromellitic diimide dilithium salt. In some embodiments, the cathode comprises at least 50 vol % imide.

In some embodiments, the catholyte is a solid catholyte. In some embodiments, the solid catholyte is a solid catholyte selected from a group a polymer, an organic ionic plastic crystal, and a halide. Specific examples of solid catholytes include PVDF mixed with a Li salt (e.g., LiTFSI), succinonitrile mixed with a Li salt (e.g., LiTFSI or lithium iodide), Li₃YBr₆, Li₃YCl₆, and Li₃InCl₆.

In some embodiments, the catholyte is a liquid catholyte. In some embodiments, the liquid catholyte comprises an organic liquid catholyte. In some embodiments, the organic liquid catholyte is an organic liquid catholyte from a group 1M LiPF₆ in 1:1:1 vol. EC:DMC:DEC, 1M LiFSI in 1:1 vol. EC:DMC, and 1M LiTFSI in 1:1:1 vol. EC:DMC:DEC.

In some embodiments, the liquid catholyte comprises an ionic liquid catholyte. In some embodiments, the ionic liquid catholyte is an ionic liquid catholyte from a group 1:9 mol. LiFSI:PYR13FSI and 1:9 mol. LiTFSI:PYR13FSI.

In some embodiments, the cathode further comprises a binder. In some embodiments, the binder is a binder from a group poly(ethylene oxide) (PEO), polyvinylidene fluoride (PVDF), styrene-butadiene rubber, carboxymethyl cellulose, and polyacrylonitrile.

In some embodiments, the cathode further comprises a carbon black powder. In some embodiments, the carbon black powder is about 20 vol % to 60 vol %, or about 35 vol % to 40 vol %, of the cathode.

In some embodiments, the solid-state electrolyte comprises a lithium garnet material In some embodiments, the solid-state electrolyte comprises lithium lanthanum zirconium oxide (LLZO). In some embodiments, the solid-state electrolyte is or comprises Li_{6.25}Al_{0.25}La₃Zr₂O₁₂. In some embodiments, the solid-state electrolyte is about 10 microns to 180 microns thick, or about 120 microns thick.

In some embodiments, the anode comprises a lithium alloy. In some embodiments, the lithium alloy is an Li—Mg alloy. In some embodiments, the lithium alloy comprises Li-10 wt. % Mg.

The following examples are intended to be examples of the embodiments disclosed herein, and are not intended to be limiting.

The LLZO cells described in the examples mainly used 2-hydroxy-1,4-naphthoquinone (lawsone, LS) which is a dye commonly extracted from the henna plant. LS has a reversible capacity of 307 mAh/g based on lithiation of its two carbonyl groups. It was selected both for its potentially sustainable plant-based source and its electronic and ionic conductivities, which are over an order of magnitude higher than similar quinone molecules, such as 1,4-naphthoquinone and 2-methyl-1,4-naphthoquinone. LS was infiltrated at low loading into a carbon gas diffusion layer which was then used with liquid electrolyte to demonstrate near-100% utilization. Its dimer and tetramer forms have also been investigated, and had initial capacities of 130 and 240 mAh/g, respectively, but had rapid capacity fade.

LLZO cells with LS cathodes demonstrated up to 67% cathode utilization during their 1^{st} discharge. Rapid capacity fade was observed upon cycling to a lower cutoff voltage of 1.8 V or lower. Increasing the lower cutoff voltage to 2.0 V or higher restricted utilization to only half of the LS carbonyl groups (ca. 125 mAh/g; 82% of the single-carbonyl reaction) but enabled 160 cycles with over 85 mAh/g capacity retained. If side reactions at low voltage can be eliminated and cathode structures optimized to reduce conductive carbon content, LLZO hybrid cells enable quinone cathode active materials with competitive specific capacities.

### Example—Experimental

The LLZO membranes used in this work were produced though an aqueous tape casting process developed previously. The LLZO powder (about 500 nm) had a nominal composition of Li_{6.25}AL_{0.25}La₃Zr₂O₁₂. Lithium carbonate (about 2 wt %) was added to mitigate Li loss during sintering, and MgO (about 50 nm, about 4 wt %) was added to control grain growth. Laminated LLZO sheets were sintered at about 1050° C. for about 2.5 h under flowing argon. The sintered sheets were approximately 120 μm thick, with density greater than about 95% and ionic conductivity greater than about 2×10⁻⁴ S/cm.

A Li Mg alloy foil anode was attached to the LLZO disk by melting in an Ar-atmosphere glove box. The about 10 wt % Mg Li alloy was chosen because it has been shown to enhance wetting on LLZO and improve the critical current density of Li dendrite formation when compared to pure Li. First, a circular Au pad approximately 8.77 mm in diameter was deposited via sputtering on to the anode side of the LLZO membrane to facilitate Li wetting and control the diameter of the anode. Then a small disk of Li alloy foil was gently pressed between the Au-coated side of LLZO and a stainless steel spacer. The stack was placed on a hot plate at about 200° C. Melting occurred within about 30 seconds and wetting was visible though the translucent LLZO membrane.

LS composite cathodes were made with both poly(ethylene oxide) (PEO) and polyvinylidene fluoride (PVDF) as binders with acetonitrile (ACN) and 2-butanone (MEK) used as solvents, respectively. To make the cathode slurry, LS, carbon, binder, and solvent in a mass ratio of about 5:4:1:312 were added to a polypropylene bottle along with ZrO₂ milling media and mixed overnight on a roller mill. After mixing, approximately 7 mg of the slurry was dropped and spread onto an about 9 mm diameter Al foil disk in an Ar-atmosphere glove box. The composite cathode was then weighed after drying to verify cathode loading. Performance of cells with different binders did not appear to be significantly different. During preliminary experimentation with LS cathode slurries, it was found that the type of solvent impacts the final cathode composite microstructure. Solvents such as MEK and ACN with low boiling points and fast drying times (<1 minute at 25° C.) led to small LS crystallites approximately 10 μm in diameter, while slow drying solvents like NMP (>5 minutes at 60° C.) led to growth of large, faceted crystallites that could be over 100 μm long. While in-depth characterization was not performed, the large crystallites performed poorly because of both ionic and electronic transport limitations. The 1,4-naphthoquinone (NQ) cathodes were made using the PVDF and MEK cathode slurry with about the same mass ratio as for LS.

Electrolyte (about 20 μl) was added directly to the dried cathode composite by pipette and allowed to wet the cathode before further assembly. There were 4 organic liquid (OL) and ionic liquid (IL) electrolytes used in the experiments: 1M LiPF₆ in 1:1:1 vol. EC:DMC:DEC (LiPF₆ OL); 1M LiFSI in 1:1 vol. EC:DMC (LiFSI OL); 1:9 mol. LiFSI:PYR13FSI (LiFSI IL); and 1:9 mol. LiTFSI:PYR13FSI (LiTFSI IL). Batteries were assembled into stainless steel CR2032 coin cells with stainless steel spacers and wave springs. Each LLZO cell included a small disk of carbon felt to distribute pressure across the LLZO membrane more evenly.

Liquid cells were assembled with the same stainless steel coin cell cases, Li Mg alloy anode, and LS composite cathode. A commercial polymer membrane was used as a separator. Only the LiPF₆ OL electrolyte was used in liquid cells, because LiFSI salt is incompatible with stainless steel and the ILs did not wet the polymer separator well. No carbon felt spacer was used for the liquid cells.

Battery cell impedance was characterized with electrochemical impedance spectroscopy using a potentiostat with a frequency range of 7 MHz to 100 mHz and a perturbation voltage of 10 mV. The same potentiostat was used to record a 72 h open circuit voltage hold. Battery cycling was performed with a battery testing system in a thermal chamber set to 25° C. The cycling schedule for all cells, regardless of voltage window, was 25 cycles at 20 μA followed by 10 cycles each at 25, 30, 40, and then 10 μA. For the LS cells, these currents corresponded to C-rates of 0.24, 0.30, 0.36, 0.48, and 0.12 respectively. 20 μA is equivalent to 33 μA/cm².

### Example—Comparison of LLZO Hybrid and Liquid Cells

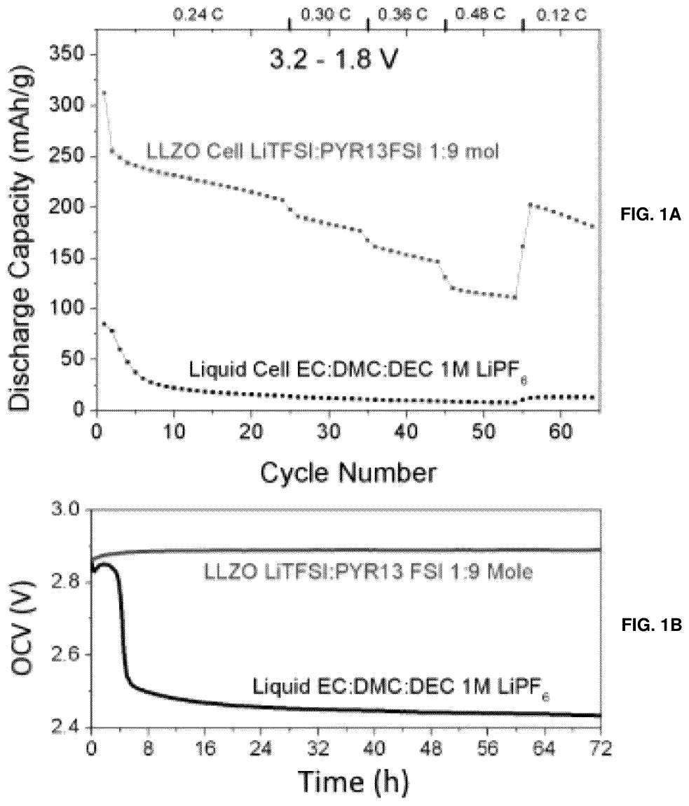

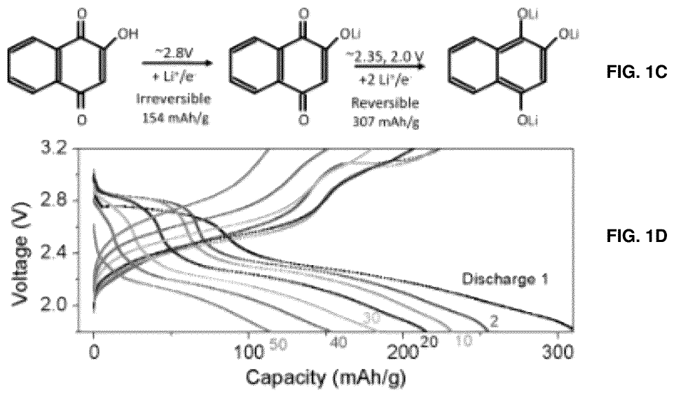

The benefits of using an LLZO sheet as an impermeable membrane to prevent dissolved lawsone transport to the anode were first confirmed by comparing a liquid electrolyte cell with a porous polymer separator to hybrid cells with an LLZO separator and liquid catholyte. The superior cycling performance of the LLZO hybrid cell is immediately apparent (FIG. 1A). The LLZO cell with LiTFSI IL catholyte had an initial discharge capacity of 312 mAh/g (101% of the 307 mAh/g theoretical 2 e⁻ reversible reaction capacity, FIG. 1C) which fell to 231 mAh/g (83%) by the 10^{th} cycle and 115 mAh/g (41%) by the 50^{th}. In contrast, the cell with the LiPF₆ OL electrolyte and a Celgard separator reached just 85 mAh/g (30.3%) in its first discharge and rapidly faded to only 8% by the 10^{th} discharge cycle. A disassembled cell clearly show the spread of dissolved lawsone into the separator and crossover to the anode surface, where it is known to react with Li. Presumably, the low initial capacity is due to crossover occurring between cell assembly and operation. These cells both used the PEO-based cathode slurry and were cycled with 3.2 V and 1.8 V upper and lower cutoff voltages, respectively, at rates from 0.12 C to 0.48 C based on the full theoretical capacity of lawsone undergoing the reversible 2 e⁻ reaction (FIG. 1C).

Open-circuit voltage holds for liquid and LLZO cells as-assembled further demonstrated the ability of LLZO to prevent self-discharge by blocking transport of the soluble lawsone (FIG. 1B). In the liquid cell, the OCV dropped rapidly from 2.8V associated with lithiation of the hydroxyl group, to approximately 2.4 V for lithiation of the 1^{st} carbonyl group after approximately 4 h. In contrast, the OCV of the LLZO cell with LiTFSI IL was relatively stable for 72 h. These comparisons to liquid cells illustrated the advantages of using the solid LLZO separator, and liquid cells were not pursued further.

During cycling, the initial discharge capacity of the LLZO cell exceeded 100%. This was expected because of irreversible lithiation of lawsone's hydroxyl group around 2.8 V. However, theoretical capacity in the case of the full 3 e⁻ reaction is 462 mAh/g. That means the utilization of cathode material was only about 67% on the first discharge. This was supported by examining the voltage behavior on in the 1^{st} discharge (FIG. 1D) as the plateaus attributed to the carbonyl groups' lithiation (2.35 and 2.0 V) account for about ⅔ of the total discharge capacity, as would be expected. Another notable feature was that the hydroxyl group lithiation at 2.8 V, which was thought to be irreversible, appears in both charge and discharge curves through 40 cycles before disappearing by cycle 50. The persistence of the hydroxyl group lithiation and de-lithiation was a feature of IL catholytes with both LiTFSI and LiFSI salts and is discussed below.

Interestingly, the coulombic efficiency of both cells was above 100% for the duration tested. This phenomenon was seen in all the lawsone cells tested. Efficiency over 100% may be expected during the initial cycles because of the effects of irreversible hydroxyl group lithiation, but the high efficiency persisted after the hydroxyl group plateau had stopped appearing in discharge curves. Evidence from varying the lower cutoff voltages, presented below, suggests this was partially caused by a reduction side reaction at low voltages. The potential liberation of H⁺ during hydroxyl group lithiation may also contribute. This was supported by comparison to the near-100% efficiency of cells with NQ, which do not contain a hydroxyl group, discussed below. Assembly of cells in the charged state and cathode material utilization below 100% may also contribute. As cycling proceeds, unused cathode material may become accessible via dissolution or other means, which can then be lithiated on discharge.

### Example—Catholyte Analysis

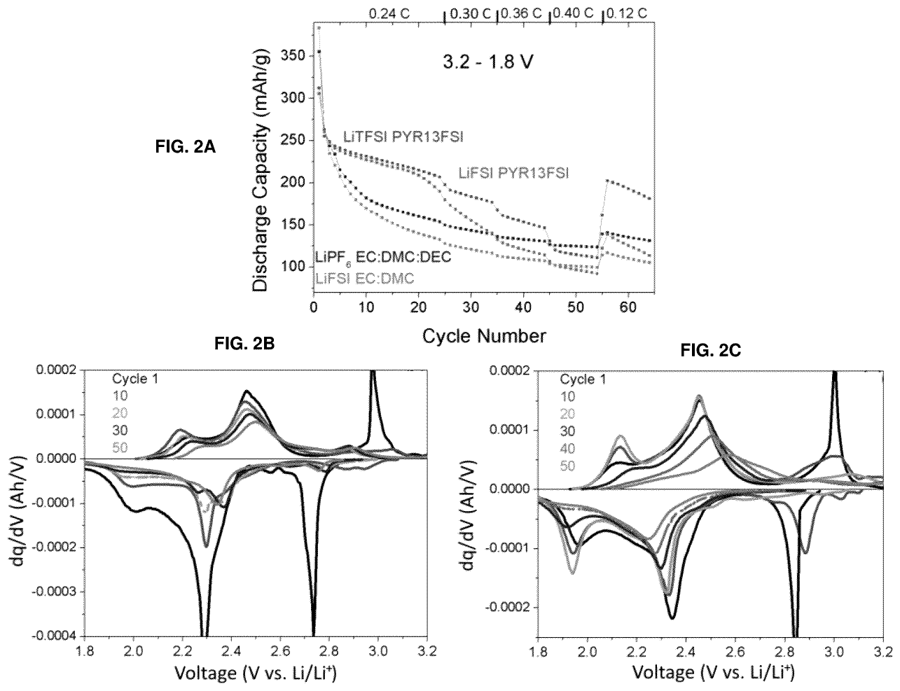

Two organic liquid and two ionic liquid catholytes were tested in LLZO cells to determine the sensitivity of cell performance to both the catholyte Li salt and solvent. The IL and OL catholytes each had a characteristic cycling behavior, independent of the type of Li salt (FIG. 2A). Cells with an OL catholyte were characterized by rapid capacity fade within the first 15 cycles, followed by more gradual fade thereafter. The IL cells had better initial stability with fade accelerating thereafter, particularly after the 55^{th} cycle. The LiTFSI IL described above provided the best performance. The best performing OL catholyte was LiPF₆ EC:DMC:DEC, which had an initial discharge capacity of 355 mAh/g (127% of the 2 e⁻ reaction) which fell to 182 mAh/g (65%) by the 10^{th} cycle and 125 mAh/g (45%) by the 50^{th}. Some of the differences in the early cycling behavior between the IL and OL catholytes were related to the lithiation and delithiation behavior of the hydroxyl group. The cells with IL catholytes appeared to have higher capacity because they can charge the hydroxyl group through more cycles than OL cells. This can be seen in the differential capacity curves above approximately 2.8 V (FIGS. 2B and 2C). In the IL cell at ca. 2.35 V, the 1^{st} carbonyl discharge peak had a broad shoulder at lower voltage, unlike the OL cell which initially had a shoulder on the high voltage side that eventually splits to a separate peak as cycling proceeds. Another difference was the behavior of the 2^{nd} carbonyl reduction peak at approximately 1.9 to 2.0 V. In the IL cell there was an activation of that peak during the first 10-20 cycles, before it started to fade. In the OL cell this peak faded away during discharge by the 10^{th} cycle. Low utilization of the 2^{nd} carbonyl lithiation below 2 V, as indicated by the low peak area, appeared to be a driver of the low total capacity.

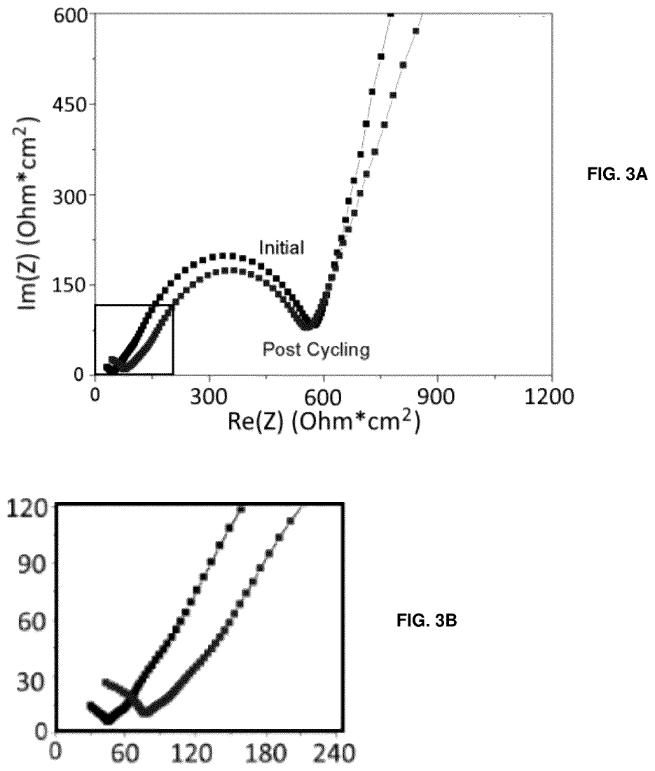

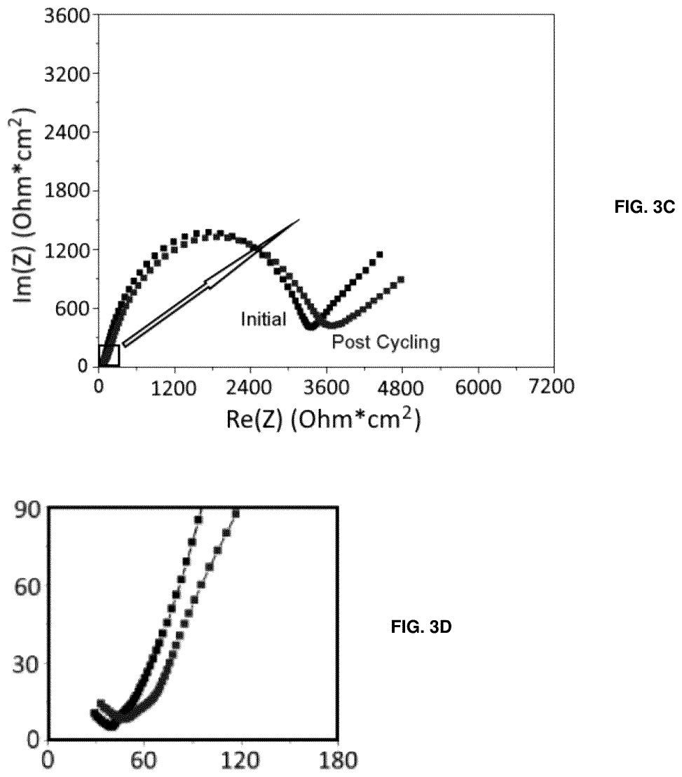

OL cells appeared to have better capacity retention at higher rates than the IL cells (FIG. 2A) because of lower overall cell impedance, even though they have very high initial fade. For example, the LiPF₆ OL cell had a seven-fold lower impedance than the LiTFSI IL cell (FIGS. 3A-3D). When the rate was increased from 0.24 C to 0.30 C the difference in impedance was, in part, responsible for the LiTFSI IL cell losing 6.1% capacity while the OL LiPF₆ cell only loses 1.3%. Both cells' total impedance changed minimally over cycling, but growth of the high frequency semicircles indicated a degradation of the ionic conductivity of the LLZO and the LLZO|catholyte interface (insets FIGS. 3B and 3D). The first high-frequency semicircle, attributed to LLZO bulk ionic conductivity, increased by 73% and 14% upon cycling for LiPF₆ OL and LiTFSI IL, respectively. These findings are consistent with previous observations that LLZO/electrolyte interactions are sensitive to the electrolyte salt composition, and that LiPF₆ reacts more severely than LiTFSI. The present data suggests LiFSI is nearly as reactive as LiPF₆, and interface degradation is tentatively proposed as the reason the LiFSI IL faded more rapidly than the LiTFSI IL.

### Example—Voltage Window Examination

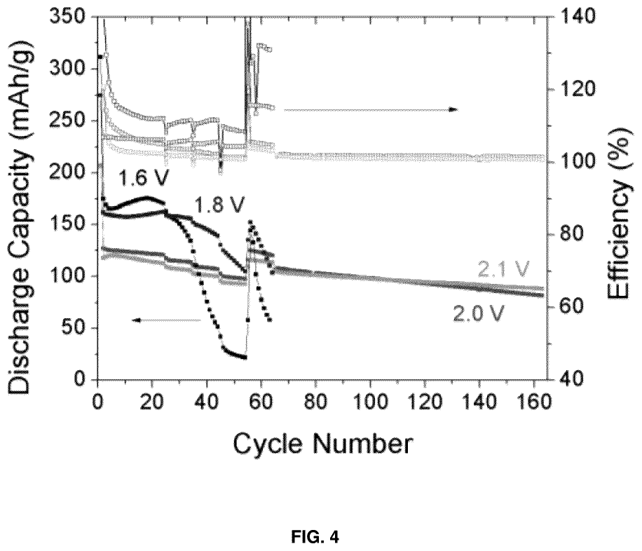

To probe LLZO cell degradation mechanisms, cells with LiTFSI IL catholyte and PVDF-based cathode slurry were cycled to several different lower cutoff voltages (LCV, FIG. 4). These cells were also operated with an upper cutoff voltage of 2.8 V to eliminate effects of charging and discharging the hydroxyl group after the 1^{st} discharge. They were run at the same rates as the previous cells, with an additional 100 cycles at 0.24 C added for the 2.0 and 2.1 V LCV cells after the original cycling schedule was complete. Cutoff voltages of 1.6 V and 1.8 V caused accelerated degradation, leading to a dramatic drop in capacity starting after about 20 and 40 cycles, respectively. For cutoff voltages of 2.0 V or greater, the fade was significantly slower. The 1.6 V LCV cell faded from 175 mAh/g in its 2^{nd} cycle to 58 mAh/g by the 65^{th} cycle (33% retained), whereas the 2.1 V cell started at 118 mAh/g and retained 113 mAh/g capacity (96%) after 65 cycles and 88 mAh/g (74%) after 165 cycles. Clearly, discharging below 2 V damages the cell, and a possible mechanism is discussed below.

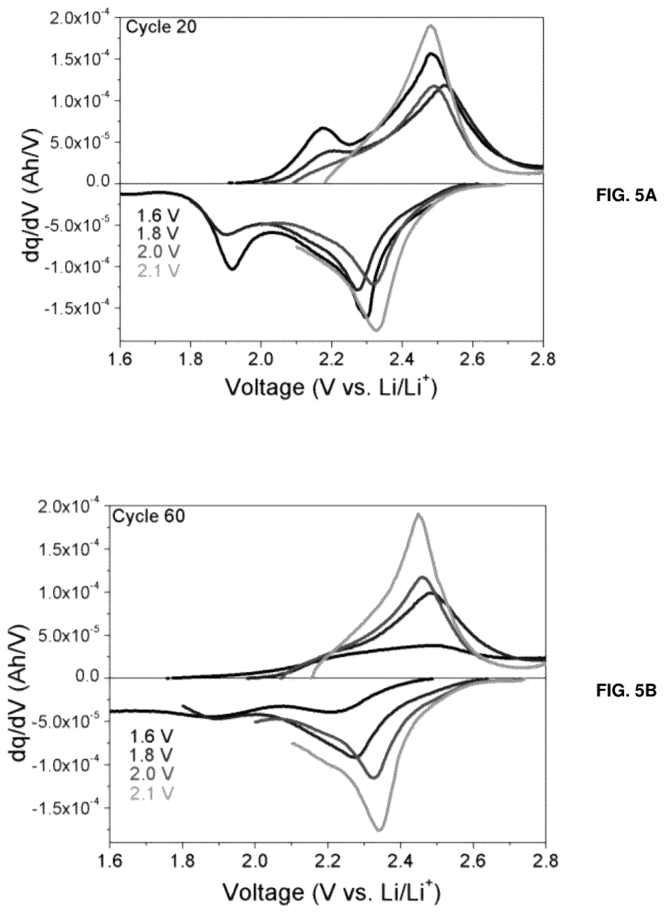

Differential capacity plots of the 20^{th} and 60^{th} cycles illustrate the relative stability of the 2.0 V and 2.1 V LCV cells and poor utilization of the 2^{nd} carbonyl lithiation during discharge below 2 V (FIGS. 5A and 5B). For the 1.6 V and 1.8 V LCV cells, the peak heights were reduced significantly during cycling, with only a small voltage shift. This is consistent with active material loss as the main driver of capacity fade, rather than increased impedance which would appear as a voltage shift. In contrast, the 2.0 V and 2.1 V LCV cells showed minimal change after cycling. Additionally, these plots confirm that the 2.0 V and 2.1 V cells do not discharge to low enough voltage to utilize the 2^{nd} carbonyl lithiation, as indicated by the absence of the peak around 1.9 V. The relatively small difference in initial capacity for all LCVs illustrates the poor utilization of the 2^{nd} carbonyl lithiation even for the 1.6 V and 1.8 V LCV. If the 1^{st} and 2^{nd} lithiations provides similar capacity, the 1.6 and 1.8 V LCF cells would have approximately twice the capacity of the 2.0 and 2.1 V cells. However, this was not the case; the 1.6 V cell had only about 40% more capacity than the 2.1 V cell.

Coulombic efficiency generally increased further above 100% with decreased cutoff voltage. This trend is expected if one of the primary drivers of efficiency above 100% is a reduction side reaction on the cathode side of the cell, which would be exacerbated at low voltage. Such side reaction would lead to longer discharge times and provide an internal charging mechanism thereby reducing the amount of external charge required on charge. It should be noted that efficiency was slightly above 100% even in the 2.1 and 2.0 V LCV cells, indicating this issue is not completely avoided at those higher LCVs.

Taken together, these results suggest that a reduction side reaction at low cell voltage consumes LS active material, and manifests as a rapid capacity fade and coulombic efficiency exceeding 100%. To curtail this reaction, a higher LCV can be used but this comes at the expense of incomplete utilization of the 2^{nd} carbonyl lithiation and therefore lower total capacity. A solution to this issue is anticipated to mitigate capacity fade and increase capacity by enabling a lower LCV which would improve utilization of the 2^{nd} lithiation.

### Example—1,4-Naphthoquinone

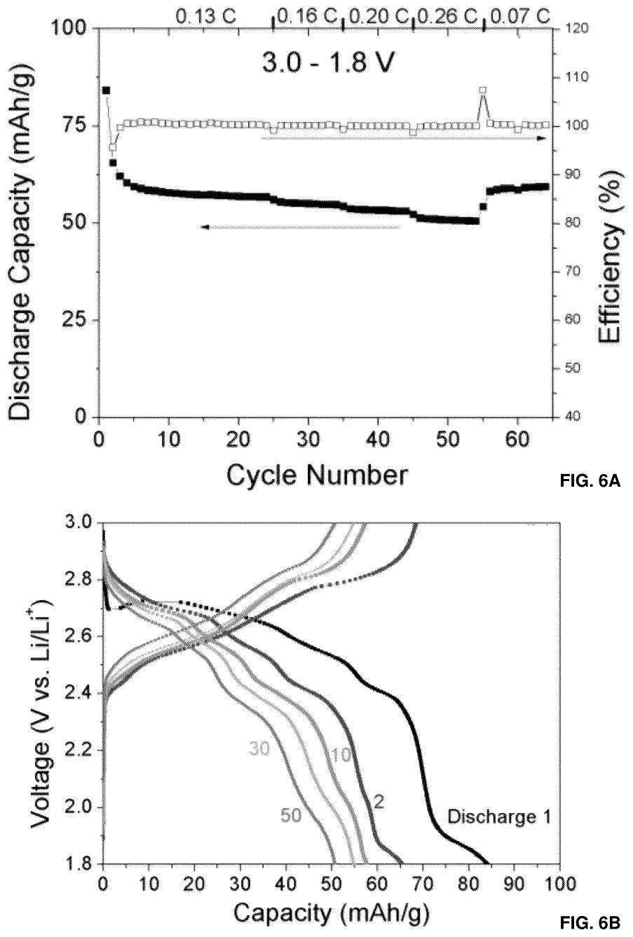

NQ is structurally identical to LS except for the absence of the hydroxyl group and was used here to verify assignment of the 2.8 V plateau to lithiation of the hydroxyl group in the LS cells. Further, eliminating the hydroxyl group removes both a source of irreversible lithiation and a potential cause of reductive side reactions stemming from the liberation of a hydrogen atom. FIG. 6A shows cycling performance of an LLZO cell with an NQ cathode and LiFSI OL catholyte. The first discharge of the cell at 0.13 C had a capacity of 84 mAh/g which is 24.7% of the 339 mAh/g theoretical capacity, and notably worse utilization than LS LLZO cells. Discharge capacity faded to 66 mAh/g in the 2^{nd} cycle and 58 mAh/g in the 10^{th}. Capacity fade in later cycles did not accelerate, in contrast to LS cells with LCVs of 1.8 V or lower. The NQ cell lost only 0.7 mAh/g over 10 cycles at 0.26 C, and capacity increased slightly over the last 10 cycles at 0.07 C. It appears that NQ cells are not subject to the same degradation mechanisms as LS cells, although their cathode material utilization is sizably worse. NQ has much lower ionic and electronic conductivity than LS, and that may contribute to the large difference in utilization. Coulombic efficiency is 95% in the 2^{nd} cycle and rises to 100.6% in the 4^{th} before slowly falling back to 100.0 by the 50^{th} cycle.

The voltage profiles confirmed assignment of the 2.8 V plateau in LS cells to hydroxyl group lithiation (FIG. 6B). When the NQ and LS profiles are compared, there was an additional plateau for the LS cells (at approximately 2.8V discharge and 3 V charge) that fades quickly to become irreversible, as expected. In contrast, the highest-voltage plateau for the NQ cell occurs at lower voltage and cycles continuously. The voltage profiles for NQ are, however, more complicated than expected for the anticipated 2 e− reaction. Three plateaus were visible between 2.7 V and 2.4 V, along with another below 2.0 V. This matched neither the expected voltages of 2.38 V and 2.29 V found from density functional theory calculations or 2.52 V and 2.32 V found experimentally in liquid cells.

### CONCLUSION

Further details regarding the embodiments described herein can be found in Robert A. Jonson et al., “Lithium Batteries with Small-Molecule Quinone Cathode Enabled by Lithium Garnet Separators,” ACS Appl. Energy Mater. 2023, 6, 2, 745-752, which is herein incorporated by reference.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A device comprising:
an anode, the anode comprising lithium;
a cathode, the cathode comprising a catholyte and an organic active material disposed therein; and
a separator disposed between the anode and the cathode, the separator comprising a solid-state electrolyte.

2. The device of claim 1, wherein the organic active material is an organic active material from a group a quinone, an organosulfur material, a sulfonated polyaniline, an imine material, an azo material, an organic acid anhydride, and an imide.

3. The device of claim 1, wherein the organic active material is a quinone, and wherein the quinone is a quinone from a group 2-hydroxy-1,4-naphthoquinone, 1,4-naphthoquinone, and 2-methyl-1,4-naphthoquinone.

4. The device of claim 1, wherein the organic active material is a quinone, and wherein the quinone comprises 2-hydroxy-1,4-naphthoquinone (lawsone).

5. The device of claim 1, wherein the organic active material is an azo material, and wherein the azo material is azobenzene.

6. The device of claim 1, wherein the organic active material is an organic acid anhydride, and wherein the organic acid anhydride is an organic acid anhydride from a group perylene tetracarboxylic dianhydride (PTCDA) and pyromellitic dianhydride (PMDA).

7. The device of claim 1, wherein the organic active material is an imide, and wherein the imide is a pyromellitic diimide dilithium salt.

8. The device of claim 1, wherein the cathode comprises about 30 vol % to 70 vol % organic active material.

9. The device of claim 1, wherein the catholyte is a solid catholyte.

10. The device of claim 1, wherein the catholyte is a solid catholyte, and wherein the solid catholyte is a solid catholyte selected from a group a polymer, an organic ionic plastic crystal, and a halide.

11. The device of claim 1, wherein the catholyte is a liquid catholyte.

12. The device of claim 1, wherein the catholyte is a liquid catholyte, and wherein the liquid catholyte comprises an organic liquid catholyte.

13. The device of claim 1, wherein the catholyte is a liquid catholyte, wherein the liquid catholyte comprises an organic liquid catholyte, and wherein the organic liquid catholyte is an organic liquid catholyte from a group 1M LiPF₆ in 1:1:1 vol. EC:DMC:DEC, 1M LiFSI in 1:1 vol. EC:DMC, and 1M LiTFSI in 1:1:1 vol. EC:DMC:DEC.

14. The device of claim 1, wherein the catholyte is a liquid catholyte, and wherein the liquid catholyte comprises an ionic liquid catholyte.

15. The device of claim 1, wherein the catholyte is a liquid catholyte, wherein the liquid catholyte comprises an ionic liquid catholyte, and wherein the ionic liquid catholyte is an ionic liquid catholyte from a group 1:9 mol. LiFSI:PYR13FSI and 1:9 mol. LiTFSI:PYR13FSI.

16. The device of claim 1, wherein the cathode further comprises a binder, and wherein the binder is a binder from a group poly(ethylene oxide) (PEO), polyvinylidene fluoride (PVDF), styrene-butadiene rubber, carboxymethyl cellulose, and polyacrylonitrile.

17. The device of claim 1, wherein the cathode further comprises a carbon black powder.

18. The device of claim 1, wherein the solid-state electrolyte comprises a lithium garnet material

19. The device of claim 1, wherein the solid-state electrolyte comprises lithium lanthanum zirconium oxide (LLZO).

20. The device of claim 1, wherein the solid-state electrolyte comprises Li_{6.25}Al_{0.25}La₃Zr₂O₁₂.
